(19) United States
(12) Patent Application Publication
(10) Pub. No.: US 2011/0161194 A1
(43) Pub. Date: Jun. 30, 2011

(54) Recommending a shoe size based on best fitting past shoe purchases

(76) Inventors: Michael A. Dumke, Granite Bay, CA (US); Michael B. Briare, Granite Bay, CA (US)

(21) Appl. No.: 12/655,553

(22) Filed: Dec. 31, 2009

(51) Int. Cl. G06Q 99/00; G06Q 30/00; G06Q 50/00; G06F 15/16; G06F 17/30; G01B 1/00

(52) U.S. Cl. 705/26.7; 705/347; 709/203; 707/769; 33/515; 707/802; 707/E17.014; 707/E17.044

(57) ABSTRACT

An application on an e-commerce website predicts the best fitting size of a desired shoe type selected by a user based on the best fitting shoes previously purchased by the user. A robotic measuring device is used to measure the inner dimensions of sizes of many shoe types, including first and second shoe types. The application determines that the user has purchased the first shoe type in a first size that fit the user well. The application compares the dimensions of the first size to the dimensions of various sizes of the second shoe type and identifies a second size of the second shoe type whose dimensions match the dimensions of the first size. The first shoe type is chosen from a shoe category similar to that of the second shoe type. The application then recommends that the second size of the second shoe type will fit the user well.

### TECHNICAL FIELD

The present invention relates generally to determining the best fitting size of a shoe and specifically to recommending the best fitting size based on a user's past shoe purchases.

### BACKGROUND

The problem of choosing the correct shoe size has existed since the shoes began to be mass produced in standard sizes. Many devices have been developed to assist customers in determining the shoe size that most closely corresponds to the customers' foot size, most notably the device developed by Charles Brannock and disclosed in U.S. Pat. No. 1,725,334. These devices require the physical measurement of a customer's foot and are most appropriate for in-store use. With the advent of e-commerce, however, the need arose to determine the best fitting shoe size of an online customer without using a physical foot measuring device. Online customers typically do not possess a physical foot measuring device. Moreover, the task of determining the correct shoe size for an online purchaser is further complicated by the fact that the inner dimensions of one manufacturer's shoe size often do not correspond to,those of the same shoe size of another manufacturer.

One method of determining the correct shoe size for an online customer is disclosed by Agostino in U.S. Pat. Pub. No. 2007/0011173. Agostino develops a customer database with a shoe purchase history and an indication of how well each previously purchased shoe fits. The purchase history is used to generate a fit profile for the customer and a “virtual shoe closet” for the customer. The fit profile indicates the size and style of shoes that the customer typically wears.

If the customer later decides to purchase a particular shoe that is already in the virtual shoe closet, the system of Agostino recommends a size of the particular shoe that will fit the customer based on past purchases by the customer of that particular shoe. If the customer decides to purchase a shoe that is not in the virtual shoe closet, the system of Agostino attempts to find another system user with a similar fit profile and recommends the shoe size that fit the other system user. However, if the shoe to be purchased is neither in the customer's virtual shoe closet nor in the virtual shoe closet of any other system user with a similar fit profile, then the system of Agostino recommends a shoe size based on physical foot measurements that the purchaser must enter into the customer's fit profile. Where neither the online customer nor another system user has rated the shoe to be purchased, however, the system of Agostino does not account for the fact that the inner dimensions of the shoe to be purchased often differ from those of any other shoe of the same size but of a different type.

A method is sought for determining the shoe size that best fits an online customer of a shoe that the customer has not previously purchased without requiring the customer to perform a physical foot measurement and without relying on ratings from third parties regarding how well particular shoe sizes fit those third parties.

### SUMMARY

A software application integrated into e-commerce website software predicts the best fitting size of a desired shoe type selected by a user based on the best fitting shoes previously purchased by the user. The application overcomes the problem that few shoe types are manufactured true to size and allows the user to determine the size of the desired shoe type purchased online that will fit the user. The application recommends the best fitting shoe size without requiring the user to perform a physical foot measurement and without relying on information as to which size of the desired shoe type has fit another user. The application and the e-commerce website software run on a web server of an e-commerce merchant.

A robotic measuring device is used to measure the inner dimensions of sizes of many shoe types, including a first shoe type and a second shoe type. The application determines that the user has purchased the first shoe type in a first size that fit the user well. The application compares the inner dimensions of the first size to the inner dimensions of various sizes of the second shoe type selected by the user and identifies a second size of the second shoe type whose inner dimensions match the inner dimensions of the first size. The application then recommends that the second size of the second shoe type will fit the user well.

In comparing the inner dimensions of the first and second shoe types, the application chooses a first shoe type that falls within shoe categories similar to those of the second shoe type that the user desires to purchase online. Each shoe type is categorized as belonging to one or more shoe categories, such as athletic shoes, dress shoes, casual shoes, high-heel shoes, open-toe sandals, boots, lace-up shoes, slip-on shoes, men's shoes, women's shoes, boys' shoes, and girls' shoes. Thus, the application is a computer program that executes instructions stored on a computer readable medium of the web server and that selects the first shoe type based on the second shoe type selected by the user.

The application determines that the inner dimensions of the second size of the second shoe type match the inner dimensions of the first size of the first shoe type if a fit factor exceeds a predetermined threshold. The fit factor is calculated by comparing the inner dimensions of the first size to the inner dimensions of the second size and is adjusted based on the similarity of the categories of the first shoe type to the categories of the second shoe type. In one embodiment, weighted inner dimensions are compared in order to calculate the fit factor. For example, the foot length and foot width dimensions are assigned the greatest weighting.

A system for recommending a best-fitting size of a shoe purchased online includes a shoe dimension database, a user database, a shoe size predictor application and a shoe measuring device. The shoe dimension database contains first inner dimensions of a first size of a first shoe type and second inner dimensions of a second size of a second shoe type. The inner dimensions of many shoe types, including the dimensions of the first and second shoe types, are measured using the same shoe measuring device. The system provides a size recommendation to the user who desires to purchase the second shoe type. The user database contains a fit profile of the online user with a list of sizes of shoe types that each fit the user well. The list includes the first size of the first shoe type.

The size predictor application runs on a web server of an e-commerce merchant. A web browser executes on the user's computer and renders documents served up by the application. The application determines that the second inner dimensions of the second size match the first inner dimensions of the first size. Then the application recommends to the user that the second size of the second shoe type will fit the user well.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a simplified schematic block diagram of various components of a system for predicting which size of a desired shoe type will best fit a user based on the best fitting shoes previously purchased by that user.

FIG. 2 is a flowchart of steps by which the system of FIG. 1 generates a database of the inner dimensions of many shoe types.

FIG. 3 is a flowchart of steps for generating a database containing information on previous shoe purchases of each user of the system of FIG. 1.

FIG. 4 is a flowchart of steps by which the system of FIG. 1 uses the contents of the databases to recommend the best fitting size of the desired shoe based on past purchases of other shoes by the user.

FIG. 5 is a schematic representation of the contents of the shoe dimension database of FIG. 1.

FIG. 6 is a schematic representation of the contents of the user database of FIG. 1.

FIG. 7 is a screenshot generated by a shoe size predictor application running within an e-commerce website in which historical shoe purchase information is requested from the user of the system of FIG. 1.

FIG. 8 is a screenshot in which the system of FIG. 1 provides a size recommendation for the desired shoe being purchased online by the user.

FIG. 9 is a table showing fit factors that are calculated for various sizes of the desired shoe and upon which the size recommendation is based.

### DETAILED DESCRIPTION

Reference will now be made in detail to some embodiments of the invention, examples of which are illustrated in the accompanying drawings.

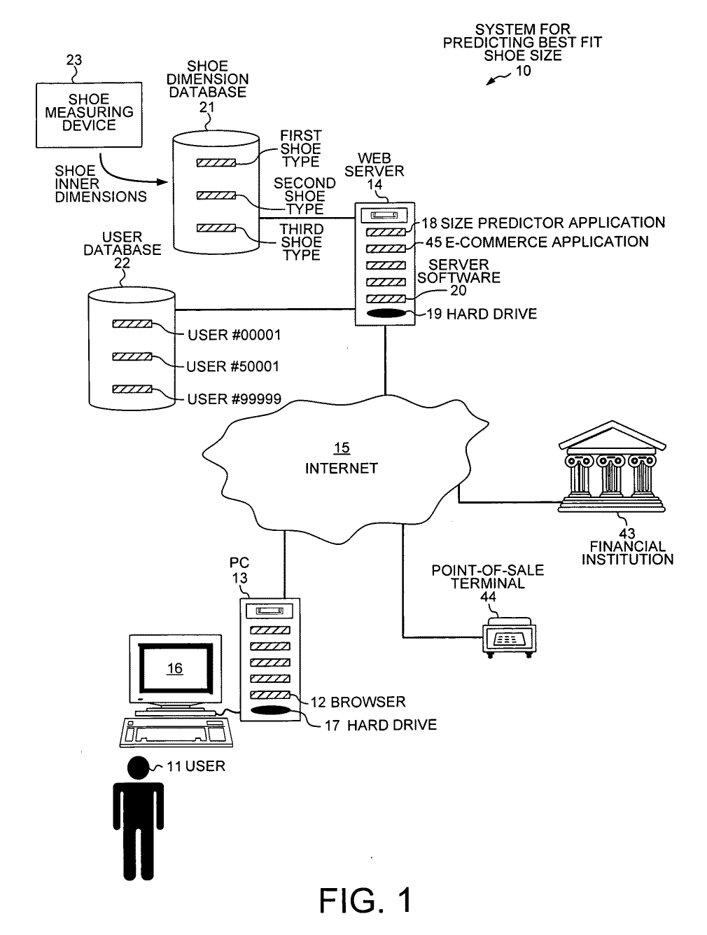

FIG. 1 shows a system 10 for predicting which size of a selected shoe type will best fit a user 11 of system 10 based on the best fitting shoes previously purchased by user 11. User 11 is an online customer of shoes who is purchasing shoes from an e-commerce website, such as Amazon.com, Walmart.com or Zappos.com. System 10 is used to determine the best fitting shoe size of a shoe that user 11 has not previously purchased without requiring user 11 to perform a physical foot measurement and without relying on information as to whether the particular shoe has fit a third party. By accurately recommending a shoe size of a selected shoe type, system 10 reduces the number of ill-fitting shoes that are returned to the e-commerce merchant.

User 11 shops online for shoes using a web browser 12 running on a personal computer 13 that renders hypertext documents that are served up by a web server 14 of the e-commerce merchant. The hypertext documents (web pages) are transmitted to web browser 12 via the Internet 15. Personal computer 13 may, for example, be a conventional personal computer, a laptop computer or a workstation. User 11 responds to information displayed in the web pages on the user's screen 16. The hard drive 17 of user's PC 13 is a computer readable medium that stores browser 12, which is executed by the processor of PC 13.

System 10 includes a shoe size predictor application 18 running on web server 14. Web server 14 includes a hard drive 19 that is a computer readable medium that stores size predictor application 18. The processor of web server 14 executes both application 18 as well as server software 20. System 10 also includes a shoe dimension database 21, a user database 22 and a shoe measuring device 23. System 10 performs a method for predicting the best fitting shoe size by generating and maintaining both shoe dimension database 21 and user database 22.

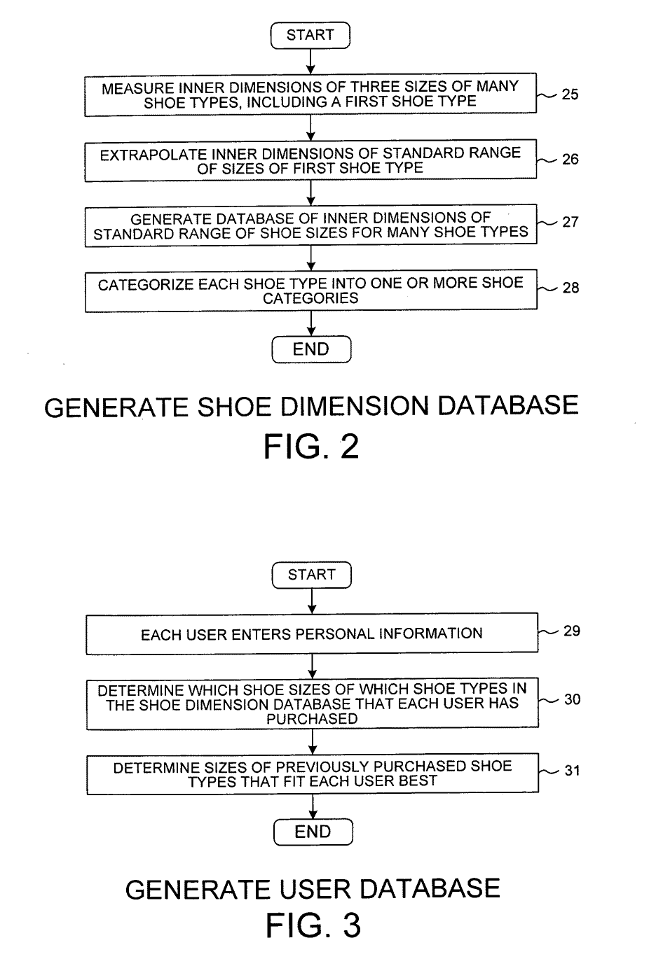

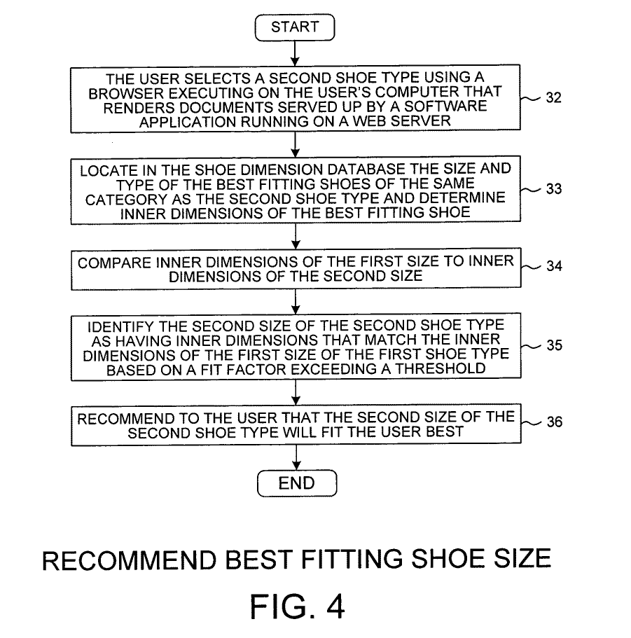

FIGS. 2-4 are flowcharts illustrating portions of the method for predicting the best fitting shoe size of an online shoe purchase. FIG. 2 illustrates steps 25-28 of a method by which system 10 generates database 21 of the inner dimensions of many shoe types. FIG. 3 illustrates steps 29-31 of a method by which system 10 generates database 22 containing information on previous shoe purchases of each user of system 10. And FIG. 4 illustrates steps 32-36 of a method by which system 10 uses the contents of databases 21-22 to recommend to user 11 the best fitting size of a prospective purchased shoe based on past purchases of other shoes by user 11. The steps of FIGS. 2-4 will now be described in relation to the operation of system 10 as shown in FIG. 1.

System 10 predicts the best fitting shoe size of a prospective shoe purchase by analyzing which shoe purchases best fit user 11 in the past. Instead of measuring the dimensions of the feet of user 11, system 10 measures the inner dimensions of shoes that best fit the feet of user 11 in past purchases. Thus, user 11 need not possess any costly foot measuring equipment, such as a Brannock foot measuring device. Moreover, user 11 is not required to measure his or her feet on a paper printout. Foot dimensions obtained from online customers who compare their feet to a scale on a paper printout are likely to be inconsistently applied and therefore inaccurate. System 10 performs all measurements on shoes in a consistent manner instead of relying on foot measurements performed by each user in a non-uniform manner.

FIG. 2 illustrates the steps by which system 10 obtains the inner dimensions of a large number of shoe types and generates shoe dimension database 21. A shoe type is a particular style of shoe made by a particular manufacturer. For example, two different styles of men's wingtip dress shoes made by the same shoe manufacturer would be two types of shoes. The same shoe style in different colors is a single shoe type.

In a step 25, shoe measuring device 23 is used to measure the inner dimensions of at least three sizes of each type of shoe in the database. By using the same device to measure all of the shoes, any inaccuracy in the resulting measurement of a particular dimension of one shoe will be compared to the same inaccurate measurement of a different shoe, and the inaccuracies will cancel each other. In one embodiment, shoe measuring device 23 is a robotic machine that extends flexible ruler bands into each shoe to measure various dimensions. For example, device 23 measures the inner dimensions of each shoe that correspond to the heel-to-toe foot length, the foot width at the ball of the foot, the arch length, the heel width, the arch height and the forefoot height (above the instep). The arch length is the distance between the back of the foot the ball of the foot. The arch height is the distance that the arch of the shoe is above a straight line from the ball of the foot to the heel of the foot. Even using a robotic shoe measuring device 23 that measures all of the inner dimensions of a shoe within one minute, it may take months to measure the inner dimensions of the thousands of shoe types being sold online today. In addition, as new shoe types are made available for sale, those new shoe types are measured as well. In one embodiment, only the left or the right shoe of each shoe type is measured. In another embodiment, measurements are tabulated for both the right and the left shoe.

In a step 26, the inner dimensions of the unmeasured shoe sizes are extrapolated from the at least three shoe sizes that are measured. For example, the various inner dimensions of sizes 6, 8 and 10 of a woman's tennis shoe type are measured using shoe measuring device 23. Then the corresponding inner dimensions for sizes 5, 5½, 6½, 7, 7½, 8½, 9, 9½, 10½, 11, 11½, 12, 12½ and 13 are extrapolated to obtain the dimensions for a standard range of women's shoe sizes from 5-13.

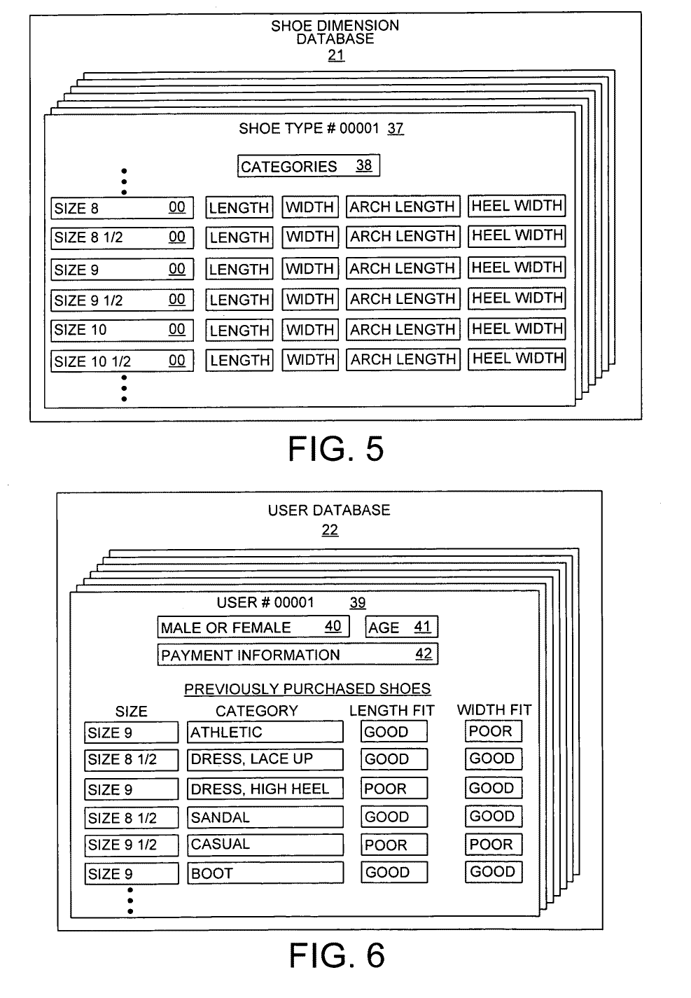

In a step 27, system 10 generates database 21 of inner dimensions of a standard range of shoe sizes for many shoe types. For example, shoe dimension database 21 includes data on tens of thousands of shoe types. FIG. 5 is a schematic representation of the contents of shoe dimension database 21. Each measured shoe type is assigned a type number 37. In one embodiment, type number 37 is the SKU number of the shoe.

In a step 28, each shoe type is allocated to one or more shoe categories 38, such as athletic shoes, dress shoes, casual shoes, high-heel shoes, open-toe sandals, boots, lace-up shoes, slip-on shoes, men's shoes, women's shoes, boys' shoes, and girls' shoes. Alternatively, each shoe type can also be categorized by sole flexibility, heel height, shoe material and amount of dead space in shoe. A shoe type can fall into more than one category, such as men's shoes, dress shoes and lace-up shoes or women's shoes, high-heel shoes and slip-on shoes. An example of an entry in shoe dimension database 21 would be shoe type #10935 in the categories women's shoes, boots and lace-up shoes with the foot length, the foot width, the arch length and the heel width for each half size and half size from 5 through 13.

In addition to generating shoe dimension database 21, system 10 also generates user database 22. FIG. 6 is a schematic representation of the contents of user database 22. FIG. 3 illustrates the steps by which system 10 generates database 22 by assembling information on previous shoe purchases for each user of system 10. Each user is assigned a user ID number 39.

In a step 29, each user of system 10 enters personal user information and builds a user profile. User 11 enters various personal information using the graphical user interface of application 18 displayed by browser 12 on screen 16. User 11 enters his or her gender 40, age 41 and payment information for shoe purchases 42. User 11 enters a username and password and uses this personal information to log into application 18. The payment information 42 includes the number of the credit card that user 11 uses to purchase shoes either from brick-and-mortar stores or online from various e-commerce websites with the aid of system 10. Alternatively, payment information 42 includes credit card payment information available from the user's financial institution 43, such as a bank or credit card company.

In a step 30, system 10 determines which shoe sizes user 11 has purchased of the shoe types in shoe dimension database 21. When user 11 purchases shoes at a brick-and-mortar shoe store and pays by credit card or debit card at a point-of-sale terminal 44, the transaction information transmitted to the user's financial institution 43 includes the shoe type and size purchased. Using the personal information in the user profile, system 10 retrieves data on the shoe type and size purchased. System 10 then searches for the shoe type in shoe dimension database 21 and stores the size of shoe that user 11 purchased. If the shoe type is not in database 21, system 10 generates a reminder to the operator of system 10 to obtain the physical measurements of the particular shoe type.

In another embodiment, the transaction information on past shoe purchases at brick-and-mortar stores is not retrieved from the user's financial institution 43. Instead, a separate software program running in parallel with the point-of-sale terminal 44 captures non-financial information about each shoe purchase, such as shoe type and size. For example, sales information software runs together with a store's enterprise resource planning (ERP) software and captures information relating to shoe sales and converts that information into a format that is entered into user database 22. Alternatively, a unit separate from point-of-sale terminal 44 sits on the checkout counter. Either the sales clerk or user 11 enters the transaction information into the separate unit.

When user 11 purchases shoes online at an e-commerce website with the aid of system 10, system 10 recommends a shoe size to purchase and stores which size was actually purchased. When user 11 purchases shoes online at an e-commerce website without using system 10, the transaction information is periodically uploaded to system 10 from the user's financial institution. For each online shoe purchase, application 18 later prompts user 11 to enter whether each inner dimension of the size of the purchased shoe type fit well.

In a step 31, system 10 determines the sizes of previously purchased shoe types that best fit each user. In predicting the best fitting size, size predictor application 18 assumes that if user 11 purchased a shoe type in a brick-and-mortar store that user 11 tried on the shoe type for fit and purchased only a size that fit well. Thus, by default application 18 enters in the user's profile for each shoe type purchased in a brick-and-mortar store that each inner dimension of the size purchased fit the user well. When logging into application 18, user 11 is periodically prompted to revise the user's fit profile by confirming that particular inner dimensions of past store-purchased shoe sizes actually fit satisfactorily. Application 18 also prompts the user to rate how well each dimension of the shoes purchased online fit. The results of the size recommendation improve as more feedback is obtained from user 11.

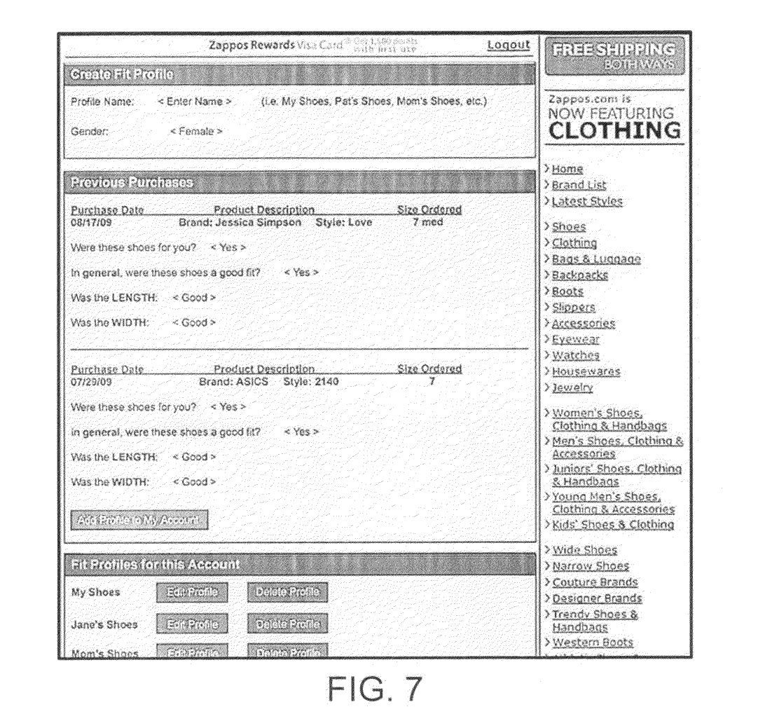

FIG. 7 shows a screenshot of application 18 running within an e-commerce website. For example, the user is asked to rate the fit of shoes with style # 2140 previously purchased on July 29, 2009. User 11 has rated the fit of both the length and the width as <Good>. In one embodiment, the fit profile of application 18 is integrated into the “my account” section of the website of the online merchant.

Application 18 then ranks past shoe purchases by the best fitting sizes in each shoe category or category group. Application 18 determines, for example, which men's lace-up dress shoe has a size with the most well fitting inner dimensions. Then application determines that the previously measured inner dimensions for that particular size of that shoe type are the best fitting inner dimensions for new shoes in the particular category group.

For example, FIG. 6 shows that both the length and the width of a previously purchased type of lace-up dress shoe of size 8½ fit well. The fit profile can also characterize the fit of other inner dimensions not shown in FIG. 6, such as arch length. In addition, an alternative embodiment of application 18 rates the fit of each inner dimension in more steps than merely poor and good. The user can be asked to rate the quality of the fit in each inner dimension on a scale from one to five, for example. Then based on the physical measurements of the type of shoe extrapolated for the size that the user has rated with the best fit, system 10 determines the physical measurements of the shoe size that best fits the user for each shoe category. System 10 determines the measurements without actually measuring the user's feet.

FIG. 4 illustrates the steps by which system 10 recommends to a user which size of a desired shoe type will best fit the user. After system 10 has generated both shoe dimension database 21 and user database 22, user 11 uses system 10 together with the website of an online merchant to purchase shoes that fit well without trying on the shoes and without measuring the user's feet. Size predictor application 18 executes together with e-commerce software 45 of the on-line merchant running on web server 14. E-commerce software 45 is also known as webshop software. In one embodiment, application 18 is integrated into e-commerce software 45 of the on-line merchant.

In a step 32, user 11 selects a desired shoe type to purchase from the selection options on the e-commerce website, such as Zappos.com. In one situation, the desired shoe type is not in the fit profile of user 11. In this example, the desired shoe type will be called the second shoe type. User 11 selects the second shoe type using browser 12 executing on PC 13 that renders documents served up by both e-commerce application 45 and size predictor application 18 running in web server 14.

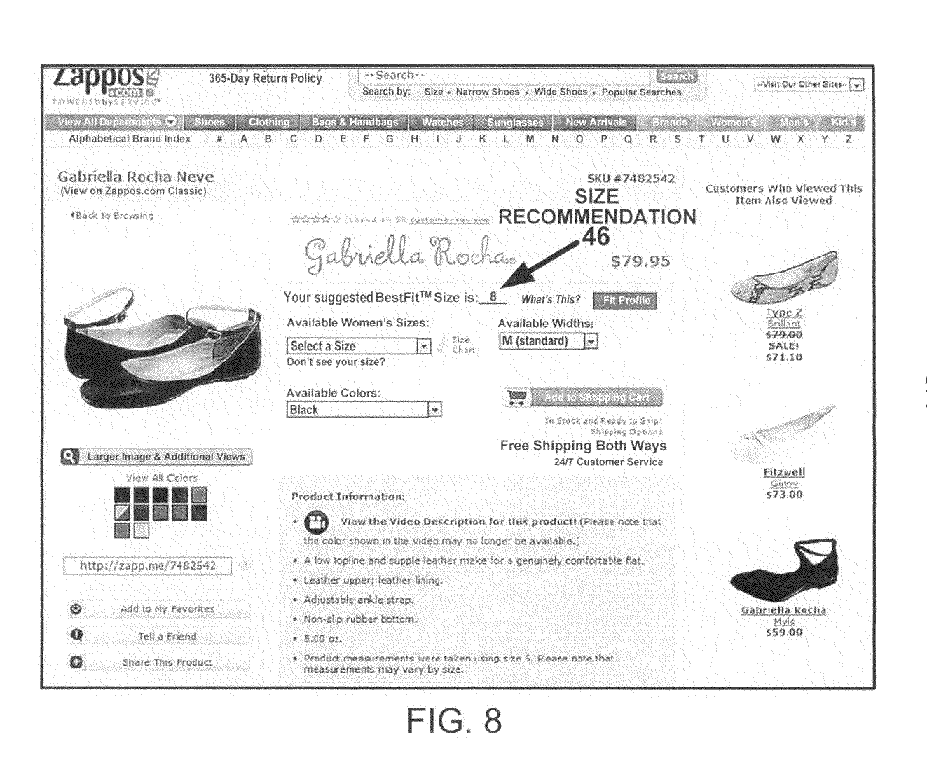

FIG. 8 is a screenshot of a web page served up by application 18 that has been integrated into e-commerce application 45. FIG. 8 shows that shoes by Gabriella Rocha designated by SKU #7482542 are of the second shoe type selected by user 11 on the website of Zappos.com. The second shoe type is in the category of casual women's slip-on shoes.

In a step 33, system 10 locates in shoe dimension database 21 the size and type of the best fitting shoes of the same category group as the second shoe type and determines the inner dimensions of those best fitting shoes. For example, system 10 searches among casual women's slip-on shoes that user 11 has purchased in the past. From among this category group of shoes types, system 10 locates a shoe type having a size whose inner dimensions best fit user 11. In one embodiment, the size and type of the reference shoe has the most inner dimensions with the highest fit ratings. The foot length and foot width dimensions are given the highest weighting from among the various inner dimensions when determining the best fitting reference shoe. In this example, the best fitting reference shoe will be called the first shoe type.

The inner dimensions of at least three shoe sizes of the first shoe type were previously measured by shoe measuring device 23 in step 25. In this example, user 11 has indicated that size 8½ of the first shoe type had the optimum fit. In step 26, system 10 determined the inner dimensions of size 8½ by extrapolating from the measured sizes eight and ten. Finally, system 10 determines that the inner dimensions of size 8½ of the first shoe type are the best fitting dimensions of shoes for user 11 in the casual women's slip-on category group.

In a step 34, system 10 compares the inner dimensions of size 8½ of the first shoe type to the inner dimensions of various sizes of the second shoe type. The inner dimensions of three sizes of the second shoe type were also previously measured in step 25 and determined for a range of shoe sizes by extrapolation in step 26.

In a step 35, system 10 identifies the size of the second shoe type that has inner dimensions that best match the inner dimensions of the reference shoe, which is size 8½ of the first shoe type. In the example of FIG. 8, size eight of the second shoe type has inner dimensions that best match the inner dimensions of the reference shoe.

When user 11 begins using system 10 and before user 11 has created an extensive fit profile, user 11 may select a second shoe type in a category for which no prior rated purchases are listed in user database 22. In that event, system 10 cannot identify matching inner dimensions of a shoe type in the same shoe category. Consequently, system 10 searches for matching inner dimensions in the most similar shoe categories. For example, if the second shoe type is lace-up casual shoes and user 11 has not rates any shoes in her fit profile in this category group, then system 10 finds matching dimensions among rated shoes in the athletic category as opposed to the high-heel category.

In one embodiment, when inner dimensions are matched from different shoe categories, the inner dimensions of differing shoe categories are adjusted. For example, application 18 compensates for the differing inner dimensions of well-fitting high-heel shoes compared to well-fitting dress shoes that fit the same feet. In addition, the adjusting is weighted for the different inner dimensions. For example, the heel width of a high-heel shoe might not be adjusted for comparison with a (non-high-heel)dress shoe, whereas the heel-to-toe length is adjusted the most.

In a second embodiment, a fit factor obtained from rating a combination of inner dimensions is adjusted as opposed to adjusting the individual inner dimensions before the fit factor is calculated. Application 18 calculates the fit factor by comparing the inner dimensions of the reference shoe of the first shoe type to the inner dimensions of various sizes of the second shoe type. The fit factor is then adjusted based on the similarity or dissimilarity of the category of the first shoe type and the category of the second shoe type. System 10 identifies the matching size of the second shoe type based on the fit factor exceeding a predetermined threshold. For example, the inner dimensions of the reference shoe would have to correspond more closely to the inner dimensions of the matching size of the second shoe type if the categories of the first and second shoe types are athletic shoes and open-toe sandals than if the categories are high-heeled dress shoes and high-heeled boots. Where inner dimensions of shoe types in the same category are matched, however, the fit factor is adjusted less, if at all.

In a step 36, system 10 recommends to user 11 that the matching size of the second shoe type will best fit the user. FIG. 8 shows that system 10 has made a size recommendation 46 that size eight of the second shoe type will be the best fitting size for user 11.

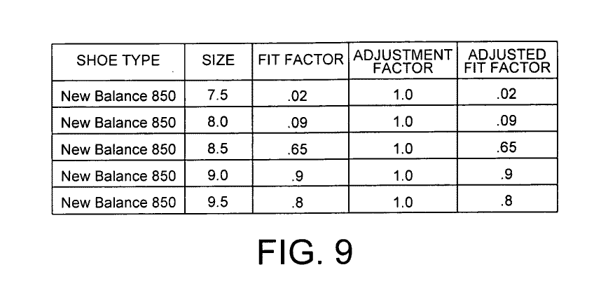

FIG. 9 is a table showing the fit factor calculated for various sizes of another example of a second shoe type. The fit profile of user 11 indicates that the inner dimensions of size eight of the shoe type “Nike Air” running shoe fit best. Size eight of the “Nike Air” running shoe is used as the reference shoe, and the fit factors for a range of sizes of a second desire shoe type, a “New Balance 850” are calculated. Because both the first shoe type and the second shoe type are in the same shoe category (athletic shoes), the fit factors are not adjusted. Size nine of the “New Balance 850” is the best match because it has the highest adjusted fit factor and because the adjusted fit factor exceeds a predetermined threshold, such as 0.8. System 10 does not recommend the size of the highest adjusted fit factor if that factor is below the predetermined threshold, for example, because the adjustment for disparate shoe categories lowered the adjusted fit factor below the threshold.

System 10 also compensates for the fact that no two feet have the identical dimensions, not even two feet on the same person. In a third embodiment of application 18, the various inner dimensions that are compared between the reference shoe and sizes of the second shoe size are not weighted so that foot length and foot width have the highest weightings. Instead, the inner dimensions that most exceed the average value for each particular dimension are assigned the highest weightings. Thus, if a user's left foot is wider than the average foot of the same shoe size, application 18 will match the inner dimensions of the reference shoe to a size of the second shoe type that has at least the required foot width. The right shoe of the second shoe type will be somewhat too wide for the user's foot, but the left shoe will fit the user's wide left foot. No better fitting pair of shoes is achievable when both shoes of a shoe pair are sold only with the same inner dimensions.

Where the e-commerce merchant permits shoe pairs to be purchased with different sized left and right shoes, an alternative embodiment of system 10 permits user 11 to rate the fit of each previously purchased pair according to the fit of the left shoe as well as the fit of the right shoe. Then steps 33-36 of FIG. 4 are performed for both the left shoe and the right shoe. In step 33, system 10 determines the inner dimensions of the best fitting left shoe in the same shoe category group, as well as the inner dimensions of the best fitting right shoe. In step 34, the inner dimensions of both the best fitting left reference shoe and the best fitting right reference shoe are compared to the dimensions of various sizes of the second shoe type. In step 35, system 10 identifies the size of the second shoe type that matches the dimensions of the left reference shoe as well as the size that matches the right reference shoe. Finally, in step 36, system 10 recommends both a size of the left shoe of the second shoe type as well as the size of a right shoe of the second shoe type.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
measuring inner dimensions of a first shoe type;
determining that a user has purchased a first size of the first shoe type;
determining that the first size of the first shoe type fits the user well;
identifying a second size of a second shoe type whose inner dimensions match the inner dimensions of the first size of the first shoe type; and
recommending that the second size of the second shoe type will fit the user well.

2. The method of claim 1, further comprising:
selecting the second shoe type, wherein the user selects the second shoe type; and
selecting the first shoe type such that the first shoe type falls within categories that match those of the second shoe type, wherein the categories of the first shoe type are taken from the group consisting of: athletic shoes, dress shoes, casual shoes, high-heel shoes, open-toe sandals, boots, lace-up shoes, slip-on shoes, men's shoes, women's shoes, boys' shoes, and girls' shoes.

3. The method of claim 1, further comprising:
selecting the second shoe type, wherein the user selects the second shoe type from an e-commerce website; and
selecting the first shoe type, wherein a computer program that executes instructions stored on a computer readable medium selects the first shoe type based on the second shoe type selected by the user.

4. The method of claim 1, further comprising:
comparing the inner dimensions of the first size of the first shoe type to the inner dimensions of the second size of a second shoe type.

5. The method of claim 4, further comprising:
measuring inner dimensions of a third size of the first shoe type, wherein the comparing the inner dimensions of the first size to the second size is performed by extrapolating the first size from the measuring of the third size.

6. The method of,claim 4, wherein the identifying the second size uses the comparing the inner dimensions, and wherein the inner dimensions that are compared are weighted such that length and width are weighted the most.

7. The method of claim 1, further comprising:
measuring the inner dimensions of the second shoe type using a device that was used to measure the inner dimensions of the first shoe type.

8. The method of claim 1, wherein the first shoe type has a first category and the second shoe type has a second category, wherein the inner dimensions of the second size of the second shoe type match the inner dimensions of the first size of the first shoe type if a fit factor exceeds a predetermined threshold, wherein the fit factor is calculated by comparing the inner dimensions of the first size and the second size, and wherein the fit factor is adjusted based on whether the first category is similar to the second category.

9. The method of claim 1, wherein the first size is a first numeral, wherein the second size is a second numeral, and wherein the first numeral equals the second numeral.

10. A system comprising:
a shoe dimension database containing first inner dimensions of a first size of a first shoe type and second inner dimensions of a second size of a second shoe type;
a user database containing a list of sizes of shoe types that each fit a user well, wherein the first size of the first shoe type is included in the list; and
a software application running on a web server, wherein a browser executing on a computer of the user renders documents served up by the software application, wherein the software application determines that the second inner dimensions match the first inner dimensions, and wherein the software application recommends to the user that the second size of the second shoe type will fit the user well.

11. The system of claim 10, wherein the user selects the second shoe type using the browser.

12. The system of claim 10, wherein the first size is a first numeral, wherein the second size is a second numeral, and wherein the first numeral equals the second numeral.

13. The system of claim 10, wherein the first inner dimensions of the first size of the first shoe type match the second inner dimensions of the second size of the second shoe type in part because the first shoe type falls within categories that match those of the second shoe type, wherein the categories of the first shoe type are taken from the group consisting of: athletic shoes, dress shoes, casual shoes, high-heel shoes, open-toe sandals, boots, lace-up shoes, slip-on shoes, men's shoes, women's shoes, boys' shoes, and girls' shoes.

14. The system of claim 10, wherein the software application determines that the second inner dimensions match the first inner dimensions by comparing weighted second inner dimensions to weighted first inner dimensions, and wherein the first inner dimensions are weighted such that length and width are weighted the most.

15. The system of claim 10, further comprising:
a shoe measuring device, wherein the first inner dimensions of the first size of the first shoe type and the second inner dimensions of the second size of the second shoe type contained in the shoe dimension database were both measured by the shoe measuring device.

16. The system of claim 10, wherein the first shoe type has a first category and the second shoe type has a second category, wherein the second inner dimensions match the first inner dimensions because a fit factor exceeds a predetermined threshold, wherein the software application calculates the fit factor by comparing the first inner dimensions to the second inner dimensions, and wherein software application adjusts the fit factor based on whether the first category is similar to the second category.

17. A system comprising:
a shoe dimension database containing first inner dimensions of a first size of a first shoe type and second inner dimensions of a second size of a second shoe type;
a user database containing a list of sizes of shoe types that each fit a user well, wherein the first size of the first shoe type is included in the list; and
means for determining that the second inner dimensions match the first inner dimensions and for recommending to the user that the second size of the second shoe type will fit the user well.

18. The system of claim 17, wherein the second size of the second shoe type is not included in the list when the means recommends to the user that the second size of the second shoe type will fit the user well.

19. The system of claim 17, further comprising:
a browser executing on a computer of the user that renders documents served up by the means, wherein the user selects the second shoe type using the browser.

20. The system of claim 17, further comprising:
a shoe measuring device, wherein the first inner dimensions of the first size of the first shoe type and the second inner dimensions of the second size of the second shoe type contained in the shoe dimension database were both measured by the shoe measuring device.
